(19) United States
(12) Patent Application Publication
(10) Pub. No.: US 2012/0215617 A1
(43) Pub. Date: Aug. 23, 2012

(54) LOCATION BASED VALUE DISSEMINATION SYSTEM AND METHOD

(75) Inventors: Kedar Shah, San Carlos, CA (US); Scott Hotes, Berkeley, CA (US); Tasos Roumeliotis, Orinda, CA (US)

(73) Assignee: Wavemarket, Inc., Emeryville, CA (US)

(21) Appl. No.: 13/031,613

(22) Filed: Feb. 22, 2011

(51) Int. Cl. G06Q 30/00

(52) U.S. Cl. 705/14.35; 705/1.1; 705/14.1

(57) ABSTRACT

A computer-implemented value dissemination method is provided. The method includes defining a physical location and detecting entrance of a mobile device associated with a user to the physical location. A value indication is generated in response to detecting the entrance to the physical location, and the value indication is rendered accessible to the user. A system for disseminating value is further provided.

### BACKGROUND

Many mobile communication devices such as cellular telephones, smart phones and the like have the ability to perform network scans to determine radio signal information, such as identifiers associated with nearby cellular base transceiver stations, WiFi™ access points and Bluetooth™ access points. Mobile devices may be further enabled to perform signal strength estimates and other signal measurements. Base transceiver stations and radio access points are primarily used for voice and data service access to the mobile device, but due to their relative permanence can be exploited for other purposes, including determining device location. Mobile devices are frequently further enabled to receive signals from Global Positioning System (GPS) satellites for estimating mobile device location coordinates.

A number of approaches exist to translate terrestrial signal information into location, including cell triangulation and trilateration techniques, such as Time Difference of Arrival (“TDOA”), Enhanced Observed Time Difference (“EOTD”), Advanced Forward Link Trilateration (“AFLT”) and Enhanced Cell Identification (“E-CID”). Such methods are considered terrestrial counterparts to the GPS satellite-based system which uses a form of triangulation based on satellite positioning. A mobile device may be configured for determining its own location, or in some cases, a remote system in communication with a mobile device may be configured to determine a mobile device's location using translation methods such as those described above. It would be desirable to use mobile device location data for advertising or promotional purposes and to enhance the experience of a user of a mobile device.

### SUMMARY

According to an embodiment, a computer-implemented value dissemination method is provided. The method includes defining a physical location and detecting entrance of a mobile device associated with a user to the physical location. A value indication is generated in response to detecting the entrance to the physical location, and the value indication is rendered accessible to the user.

According to another embodiment, a system for disseminating value comprising at least one computing device including at least one memory comprising instructions operable to enable the at least one computing device to perform a procedure is provided. The procedure includes defining a physical location and detecting entrance of a mobile device associated with a user to the physical location. A value indication is generated in response to detecting the entrance to the physical location, and the value indication is rendered accessible to the user.

According to another embodiment, a mobile device including at least one computing device including at least one memory comprising instructions operable to enable the computing device to perform a procedure is provided. The procedure includes defining a physical location and detecting entrance of the mobile device to the physical location. A value indication is generated associated with a user of the mobile device in response to detecting the entrance to the physical location, and the value indication is rendered accessible to an application executed on the mobile device.

According to another embodiment, a computer-implemented method is provided including converting recorded physical movements into virtual rewards and rendering the virtual rewards accessible and visible to a user in a user interface of a mobile application.

### BRIEF DESCRIPTION OF THE DRAWING(S)

The foregoing Summary as well as the following detailed description will be readily understood in conjunction with the appended drawings which illustrate embodiments of the invention. In the drawings:

FIG. 1 is a schematic illustration of an exemplary operating environment in which a coordination system is operable.

FIG. 2 is a flow chart showing a computer-implemented value dissemination method.

FIG. 3 is a flow chart showing another computer-implemented value dissemination method.

FIG. 4 is a plan view of an example city streetscape for illustrating methods according to embodiments of the invention.

### DETAILED DESCRIPTION OF THE PREFERRED EMBODIMENT(S)

Embodiments of the invention are described below with reference to the drawing figures where like numerals represent like elements throughout.

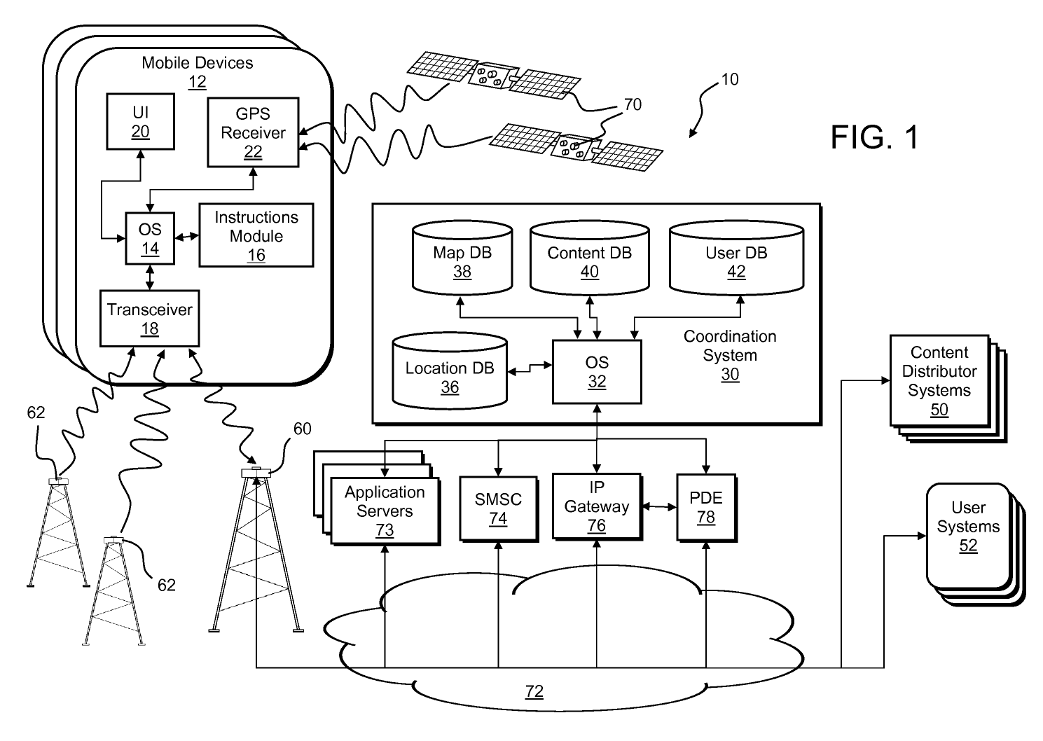

Referring to FIG. 1, a schematic illustration is shown of an exemplary operating environment 10 in which mobile device communication systems, in the form of mobile devices 12 and a coordination system 30, can be used. The mobile devices 12 and coordination system 30 each include one or more computing devices and one or more memory devices, which computing devices and memory devices can be integrally constructed or connected in any suitable manner, for example via a network. It is to be understood that a system or server as described herein comprises a computer system, as known in the art.

Each mobile device 12 preferably provides a platform which enables an operating system 14 and a module of instructions 16 preferably residing in a memory of the mobile device 12. The mobile device 12, preferably a wireless transmitting and receiving device with cellular telephone functionality, includes a transceiver 18 for communication with cellular base transceiver stations 60, 62 (“base stations”) and a user interface 20, preferably including a display and one or more audio speakers. The transceiver 18 can be further configured to communicate with other wireless stations or devices, and the mobile device 12 can alternatively support a plurality of transceivers for communication with a plurality of wireless stations or devices of differing protocols. A GPS receiver 22 is preferably provided for receiving signals from GPS satellites 70.

The coordination system 30 includes a processor or processors which enable an operating system 32 and memory or memories which permit operation of databases 36, 38, 40, 42. Preferably, collected mobile device location data is stored in a location database 36, map data corresponding to roads, addresses, building dimensions, and other definable geographic data are stored in a map database 38, advertisements or other content is stored in a content database 40, and user account information for particular users is stored in a user account database 42. The coordination system 30 is configured to collect data indicative of mobile device location of the mobile devices 12 via a telecommunication network 72, which can include the Internet and other networks, and to associate the mobile devices 12 with particular users associated with accounts in the user account database 42. The location data is preferably received in the form of tuples. Each tuple preferably includes one or more location coordinates and one or more time stamps respectively associated with the one or more location coordinates. Each tuple also preferably includes an identification (“ID”) relating the tuple to a particular mobile device and a precision indication indicating the precision and/or accuracy of the one or more location coordinates.

The tuples or other suitable mobile device location data can be received by the coordination system 30 in the form of one or more short message service (“SMS”) messages received from the mobile devices 12 via a short message service center (“SMSC”) 74, which may be integrated with the telecommunication network 72. Alternatively, location data can be sent by the mobile devices 12 using internet protocol (“TCP/IP”) and received by the coordination system 30 via an internet protocol (“IP”) gateway 76, which may be integrated with the telecommunication network 72 or otherwise situated. The coordination system 30 can alternatively query a remote position determining entity (“PDE”) 78, a Gateway Mobile Location Center (“GMLC”), or other system for disseminating location data associated with mobile devices, which PDE 78, GMLC or other system may be provided as a service by a telecommunication carrier or other party, and which systems may deliver data to the coordination system 30 via internet protocol through the IP gateway 76 or via other suitable protocol. The coordination system 30 can alternatively receive mobile device location data in any suitable manner.

One or more external application servers 73 can communicate with the coordination system 30 and execute applications which use location data provided by the mobile devices 12 or the coordination system 30 to provide content or services to a user of a particular mobile device or other users requiring data regarding a particular mobile device.

Content distributor systems 50 can transmit to the coordination system 30 content for distribution to the mobile devices 12 in the form of location-related data, which data is stored in the content database 40. Location-related data is preferably associated with addresses, building structures, geographic coordinates or geographic areas. Content distributor systems 50 are preferably associated with advertisers or other parties who provide the location-related data as advertisements, business or event names or descriptions, or other promotion material tied to one or more addresses, building structures, geographic coordinates or geographic areas. Content distributor systems 50 can include any computing devices such as personal computers or mobile devices and are preferably configured to permit a user to interface with the coordination system through a user account via a web browser or any suitable application program interface.

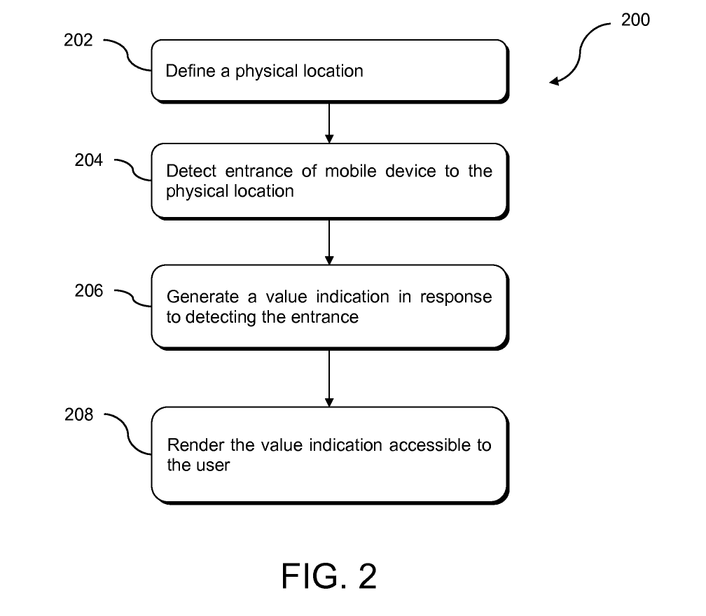

Referring to FIG. 2, a method 200 for disseminating value based on mobile device location is shown. The method 200 is described with reference to components shown in the operating environment 10 of FIG. 1, wherein the coordination system 30 is preferably configured to perform the method 200 and includes memory for storing instructions for performing the method 200. The method 200 can alternatively be performed via other suitable systems or devices. For example, a mobile device 12 can be configured to execute an application for performing the method 200. The method 200 includes defining a physical location (step 202) and detecting entrance to the physical location by a mobile device associated with a user, such as the mobile device 12 (step 204). A value indication is generated in response to detecting the entrance of the mobile device (step 206), and the value indication is rendered accessible to the user (step 208).

The coordination system 30 is preferably configured, for example, to receive location data indicative of the location of the mobile devices 12, as described above, for the purpose of detecting the entrance to the physical location. The location data can include location coordinates to permit the coordination system 30 to determine if the mobile device 12 has entered the physical location Alternatively, the location data can include an indication that the mobile device 12 has entered the physical location, for example in the case where a mobile device determines its location coordinates, detects entrance to the physical location, and transmits an indication of the detected entrance to the coordination system 30.

Preferably, the physical location is defined as a geographic area based on an indication of a physical location received in the form of an address, geographic coordinate, or other suitable location reference. For example, the coordination system 30 can receive an address, a geographic coordinate, or other data suitable for determining location from a content distributor system 50, and the coordination system 30 can define the physical location as a geographic area within a predetermined radius around the geographic coordinate or the address. Alternatively, the coordination server 30 can store dimensional data for buildings in the map database 38 or access building dimensional data from a remote system via the network 72 and define the physical location as the footprint area of a building or portion of a building corresponding to the received geographic coordinate or address. The content distributor system 50 can be operated for example by an advertiser or proprietor of an establishment, with an account on the coordination system 30, that wants a mobile device user corresponding to a predetermined demographic to enter a particular building or area where products are sold or services are rendered.

A notification related to a particular physical location is preferably transmitted to the user of the mobile device. The notification can include for example an offer or coupon to provide incentive to a user to travel to the particular physical location, such as a store where products or services can be purchased. For example, the coordination system 30 can receive an indication of a notification such as an advertisement, coupon or offer from an advertiser or proprietor of an establishment via the content distributor system 50, which notification can be transmitted to the mobile device 12. The notification is preferably transmitted to a mobile device which is then monitored for entrance to the physical location. Alternatively, the notification can be transmitted to another system operable by the user of the particular mobile device. For example, the coordination system 30 can transmit the notification to a user system 52, such as an Internet-connected personal computer, which user system 52 is operated by a particular user also identifiable as a user of a particular mobile device 12. For example, a user can initiate a connection to the coordination system 30 via the Internet or other network from both a mobile device 12 and a user system 52 at different times or the same time via a particular user account, which user account facilitates identification of the user regardless of whether the user connects using the mobile device 12, the user system 52, or another device or system. The coordination system 30 can maintain details of user accounts for each user in the user account database 42. In an alternative example, a user can initiate a connection via a particular user account to an application server 73 hosting an user-interactive application such as a game, a social networking application, or a store coupon distribution service, which application server 73 can provide information to the coordination system 30 for identifying the user of the mobile device 12 or the user systems 52.

The value indication is preferably generated in response to detecting the entrance to the physical location after the transmission of the notification, operating as a virtual reward to a user for entering the physical location. The value indication can further be generated in response to detecting the entrance to the physical location within a predetermined time of transmitting the notification, wherein if the entrance to the physical location occurs after the predetermined time, no value is generated. By setting such predetermined time, a causal connection between the transmission of the notification and the entrance to the physical location can be established. For example, a notification to a user from the coordination system 30 can include an indication of the predetermined time such that the user knows by what time he or she must enter the physical location to receive value.

A plurality of physical locations can be defined and entrance of the mobile device associated with the user to the plurality of physical locations can be detected. The value indication can be generated in response to detecting entrance to one of the plurality of locations, some of the plurality of locations, or all of the plurality of locations. For the purpose of the systems and methods described herein, generation of a value indication can correspond to an initiation of a new value indication or the increase in value of an existing value indication. For example, a new value indication can be generated when a mobile device 12 associated with a user enters one of a plurality of defined physical locations, and the value indication can be increased each time the user enters another of the plurality of physical locations. The coordination system 30 can store generated value indication for each user in the user account database 42.

One or more notifications related to the plurality of physical locations can be transmitted to the user via a mobile device or other user system. The value indication is preferably generated in response to detecting the entrance to one of the plurality of locations, some of the plurality of locations, or all of the plurality of locations after the transmission of the notification, and more preferably, within a predetermined time after transmission of the notification. For example, the coordination system 30 can transmit one or more notifications to a user's mobile device 12 or other user system 52 including advertisements for three different stores corresponding to three different physical locations, and when it is determined that the user's mobile device 12 has entered all of the physical locations, a value indication in the form of exchangeable points, exchangeable credit, store credit, coupons, or other redeemable benefit is generated and provided to the user via the user's account by the coordination system 30. In an alternative extension of the preceding example, when it is determined that the user's mobile device 12 enters a first one of the three physical locations, a value indication is generated, and the value indication is increased upon determining that the user enters the second physical location and increased again upon determining that the user enters the third physical location. In another example, a value indication can be generated when the mobile device 12 is determined to have entered one particular physical location a predetermined number of times, or alternatively, the value indication can be increased each time the mobile device 12 enters the one particular location, wherein it is preferable that such value indication is generated or increased responsive to detected entrances to the particular physical location separated by a suitable length of time, for example one day or one week.

A transmitted notification can be related to one or more products. Machine readable coding associated with a product included in the notification can be detected via the mobile device, and a value indication can be generated in response to detecting the machine readable coding after the transmission of the notification. For example, the coordination system 30 can transmit to a user via the mobile device 12 or other user system 52 an advertisement for a particular product at a particular store; the coordination system 30 can detect when the mobile device 12 is at the particular store; the user can capture with a camera on the mobile device 12 a photo of machine readable coding in the form of a barcode from the particular product and transmit the photo to the coordination system 30; the coordination system 30 can generate a value indication in response to detecting the presence of the mobile device 12 at the particular store and in response to detecting the barcode transmitted by the mobile device 12. A value indication can alternatively be generated responsive to detecting a purchase of the product, for example by detecting a barcode of a store receipt photographed via the mobile device 12, which store receipt indicates such purchase. Other suitable machine readable code can be detected, for example computer recognizable text or pictures on product packaging and RFID tags emitting signals receivable by the mobile device 12.

A region can be defined related to the physical location, wherein when the mobile device 12 is detected to have entered the region, the notification is transmitted to the mobile device 12. The region can be defined as an area within a predetermined distance of the physical location. For example, the coordination system 30 can receive an address and an advertisement from an advertiser corresponding to a particular retail store via a content distributor system 50; the coordination system 30 can define the physical location as an area within a first predetermined distance of a geographic coordinate corresponding to the address (e.g. 50 meters) or based on known building footprint dimensions at the geographic coordinate; the coordination system 30 can define the region as an area within a second predetermined distance greater than the first predetermined distance (e.g. 1 km) of the address; wherein when the coordination system 30 detects the mobile device 12 to have entered the defined region, a notification including the advertisement is transmitted to the mobile device 12; and wherein if the coordination system 30 detects the mobile device 12 to have entered the defined physical location after transmitting the notification, a value indication is generated. Alternatively, the region can be defined based on factors unrelated to the physical location, for example based on location of an advertiser's competitor's store location.

A prescribed day or a prescribed time of day can be defined, wherein a mobile device associated with a user can be detected to have entered the physical location at the prescribed day or the prescribed time of day, and wherein the value indication is generated in response to detecting the entrance to the physical location on the prescribed day or at the prescribed time during a day. For example, a notification can be transmitted to a user of the mobile device 12 which includes a notification of a benefit available at a particular address, on a prescribed day and/or during a prescribed time of day (e.g. Tuesday, between 3:00 pm and 6:00 pm), and the value indication can be generated in response to user's mobile device 12 being detected at the particular address at the prescribed day and time of day, wherein no value indication is generated in response to the user arriving at the address at a different day or time. A prescribed duration of time can also be defined, wherein a mobile device associated with a user can be detected to have entered the physical location and remained at the physical location for at least the prescribed duration of time, and wherein the value indication is generated in response to detecting the presence of the mobile device at the physical location for at least the prescribed duration of time. For example, a notification can be transmitted to a user of the mobile device 12 which includes a notification of a benefit available at a particular retail store at a particular location if the user maintains a presence at the retail store for a prescribed period of time (e.g. 30 minutes), and the value indication can be generated in response to user's mobile device 12 being detected at the particular address at the retail store for the prescribed time period, which value indication can correspond to a benefit such as a store credit or points redeemable for a store credit usable for merchandise purchase or points usable for a game hosted by an application server 73 via the Internet.

The physical location can be defined based on an indication from an application executed on the mobile device. For example, a game executed on the mobile device 12 in communication with the coordination system 30 and an application server 73 providing updated game data can provide an indication of one or more physical locations to the user of the mobile device 12 via the user interface 20; the coordination system 30 can generate the value indication in response to detecting the entrance to the one or more physical locations determined by the game.

The value indication generated in the manners described above can be used as negotiable currency or credit tied to a particular virtual online space or marketplace, virtual or physical. The value indication can be rendered accessible to an application executed on a mobile device or a remote application server. For example, a gaming application executed on a mobile device 12 can query the coordination system 30 for value indications related to an account of the user of the mobile device 12.

The method can further include receiving a request for redemption of the value indication, performing a value exchange including the value indication in response to the request for redemption, and rendering an indication of the value exchange accessible to the user. For example, the coordination system 30 can be configured to receive a request from a user via a mobile device 12 or other user system 52 to redeem a value indication associated with the user in the form of earned points in exchange for store purchase credits distributable by the coordination system 30 based on permissions granted by entities issuing the credits. Such credit-providing entities can include advertisers or proprietors of establishments maintaining accounts on the coordination system 30 which provide permissions and associated terms for the exchange via content distributor systems 50. Such store purchase credits can be transmitted to the user in the form of printable coupons or other suitable media. In another example, a value indication in the form of earned points can be exchanged for points in an application such as a game played by a user and executed on the mobile device 12, user system 52, coordination system 30, and/or the application server 73.

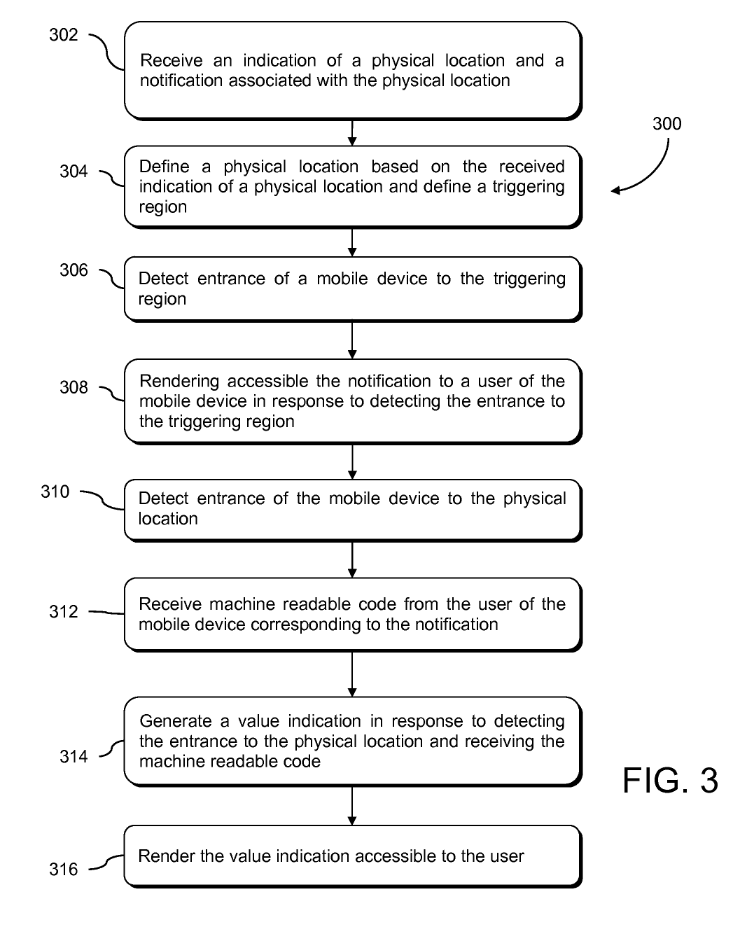

FIG. 3 shows a method 300 according to an example embodiment of the invention. The method 300 can be performed by a network accessible system, for example the coordination system 30 in the operating environment 10, in communication with a mobile device 12 and other systems via the network 72. Alternatively, the method 300 can be executed as an application on a network connectable mobile device such as the mobile device 12 including processor(s) and memory suitable for executing the application. In the method 300, an indication of a physical location and an indication of a notification associated with the physical location (step 302). An indication of a triggering region can also be received. For example, the indication of a physical location can include an address of a particular building where a product or service is sold and the notification can include an advertisement for the product or service. The triggering region can include for example a distance of a mobile device from the physical location which would trigger the transmission of the advertisement to the mobile device. Such indications can be received via a network from a system operated for example by an advertiser or proprietor of an establishment that wants mobile device users to enter a particular building or area where products are sold or services are rendered. A physical location is defined based on the received indication of the physical location and a triggering region is defined (step 304). The triggering region can be defined based on the physical location and/or based on received criteria. Entrance of the mobile device to the triggering region is detected (step 306), and the notification is rendered accessible to the user of the mobile device in response to detecting the entrance of the mobile device to the triggering region (step 308). Entrance of the mobile device to the physical location associated with the notification is detected (step 310). Machine readable code, for example photographed with the mobile device from packaging of a product associated with the notification, is received corresponding to the notification (step 312). A value indication is generated in response to detecting the entrance to the physical location and receiving the machine readable code (step 314), and the value indication is rendered accessible to the user of the mobile device (step 316).

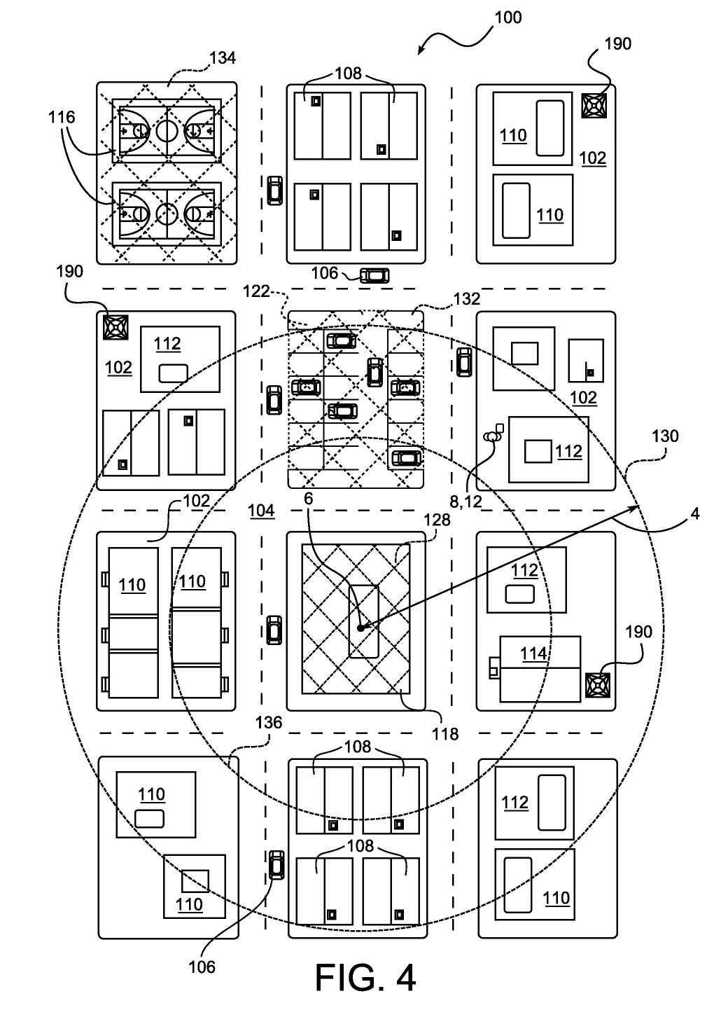

A plan view of an example city streetscape 100 is shown in FIG. 4 for the purpose of demonstrating an example computer-implemented method of the invention, which can be performed for example by the coordination system 30 of FIG. 1 or an application executed on a mobile device 12. The streetscape 100 includes city blocks 102 separated by streets 104 permitting travel of vehicles 106. Various building structures are provided on the city blocks 102 including physical locations corresponding to homes 108, offices 110, retail stores 112, a theater 114, playing courts 116, a supermarket 118, a restaurant 120, and a parking lot 122. A user 8, carrying a mobile device 12, walks or drives a vehicle 106 within the streetscape 100.

In the example illustrated by FIG. 4, the coordination system 30 receives from an entity promoting a business or product via a content distributor system 50: a) an indication of a physical location in the form of an address of the supermarket 118, b) a notification in the form of an advertisement including a description of the supermarket 118 and a product (e.g. a sport energy beverage) sold at the supermarket 118, c) an indication of a triggering region associated with the notification in the form of a preferred triggering distance 6 from the address of the supermarket 118 used to define the triggering of the advertisement, d) a predetermined user criteria such as user age or gender, and e) an indication of a reward in the form of points or credits. In a variation of this particular example, the coordination system 30 can alternatively receive the advertisement regarding the supermarket 118 without reference to a particular product, triggering distance, predetermined user criteria or indication of a reward, wherein the coordination system 30 can respectively substitute corresponding default values.

The coordination system 30 defines a physical location as a footprint area 128, represented by dashed hashing, of the supermarket 118 positioned at the provided address based on building dimensional data available for the provided address. A triggering region is defined as an area within a circle 130 which radius is a triggering distance 4 and which center 6 is at a coordinate representative of the address of the supermarket 118. In variations of this particular example, the triggering region can alternatively be defined as a footprint area 132, represented by dashed hashing, of the parking lot 122 or a footprint area 134, represented by dashed hashing, of the playing courts 116.

When a user 8 carrying a mobile device 12 and meeting predetermined user criteria enters the triggering region defined by the circle 130, or alternatively the footprint area 132 or footprint area 134, the coordination system 30 transmits or otherwise renders accessible the advertisement to the mobile device 12 for display via a user interface to the user 8. Thereafter a value indication associated with the user is generated if a) the mobile device 12 is detected to enter the physical location corresponding to the footprint area 128 of the supermarket 118 and b) machine readable code corresponding to the advertised product is received. Alternatively, in a variation of this example, the value indication can be generated if the mobile device 12 is detected to enter the physical location corresponding to the footprint area 128 of the supermarket 118 or machine readable code corresponding to the advertised product is received from the user 8. The user 8 can photograph the machine readable code on the product packaging of the advertised product or a store receipt evidencing purchase of the advertised product, which photograph is authenticated by the coordination system 30 as the machine readable code corresponding to the advertised product. The value indication is rendered accessible by the coordination system 30 to the user in the form of value stored in an account in the user account database 42.

Alternatively, in a variation of the example illustrated by FIG. 4, the value indication can be generated if the mobile device 12 is detected to enter the physical location corresponding to the area within a circle 136 which includes areas near to the supermarket 118, regardless of whether the user photographs or otherwise observes a particular product at the supermarket 118. In such variation, the triggering region can be expanded or omitted and the notification can be provided to the user with or without regard to location, for example in the context of a user-interactive application such as a game sponsored by an advertiser or proprietor of a particular establishment which directs the user to or near the particular establishment and incents such travel with points obtainable in the game or credit for purchase of merchandise. Further, it may be required the user 8 maintain a presence at the physical location for a predetermined time period, in this case at our near the supermarket 118.

The generated value indication associated with the user 8 can be increased with entrances to other physical locations such as locations within or near retail stores 112 in response to advertisements provided by the same or other entities promoting products or services. Alternatively, entrances to or maintenance of a presence for a predetermined time period at multiple physical locations can be required to trigger generation of the value indication. A user 8 which in response to notifications frequently enters promoted physical locations can be rewarded with a relatively higher value indication per visit.

The value indication can be exchanged like currency to purchase coupons, for example a coupon for a product or service discount designated in the indication of the reward provided by the entity promoting the aforementioned sport energy beverage sold at the supermarket 118. The value indication can alternatively correspond to points in a virtual environment or can be traded to purchase points or value in a virtual environment, for example in an online game hosted by the coordination system 30 or an application server 73.

The mobile device 12 preferably detects its location via a GPS fix or via measurements of base station signals from base stations 190. Alternatively, the mobile device 12 or a PDE in communication with the mobile device 12 can transmit the mobile device's detected current geographic coordinates or measurements indicative of its current geographic coordinates to the coordination system 30, and the coordination system 30 can thereby determine whether a particular mobile device 12 has entered the defined triggering region or the physical location 118. Steps performed by the coordination system 30 in the example illustrated by FIG. 4 can alternatively be performed by an application executed on the mobile device 12.

Further non-limiting example embodiments of the invention follow.

In an example embodiment, a mobile gaming publisher can use generated value indications in the form of virtual currency to provide a users extra points, when the users play a game at one or more specific locations (e.g. Starbucks™ retail locations) or in specific geographic areas (e.g. San Francisco, Calif.). A system or application executed on a mobile device (e.g. smart phone client handset) can verify the operation of the game at a specific location or geographic area. The executed system or application can then alert the game to increase the user's points for playing the game at the specific location or geographic area.

In another example embodiment, physical actions and proof of presence provide users extra points in mobile games that they can redeem for purchase of goods in a network of retailers. Obtaining proof of purchase (e.g. via machine readable coding) of particular products at particular retail stores earns users value indications in the form of virtual currency that translates to additional points in their mobile games. For example, if the user of a particular game buys a Starbucks™ brand coffee, an application executed on the mobile device or network connected system verifies the proof of purchase corresponding to a receipt or product packaging through the mobile device (e.g. phone handset) and then triggers an increase in the user's points in the particular game.

In another example embodiment, when a user is in the general vicinity of a particular retail store (e.g. in same neighborhood or city), the user earns virtual currency points in a mobile game. By moving a certain distance on foot, while playing a game, a user can earn more virtual currency points. Through the mobile device, a remote system or local application identifies when a user is in the neighborhood of a particular retail store (e.g. Target™, Best Buy™, and Starbucks™). The system or application can measure via the mobile device a user's motion and distances traveled and provide virtual rewards to the user in their mobile games based on this movement. Like a scavenger hunt, users can be rewarded for the amount of stores they come near during a day. Retailers (e.g. Best Buy™, Target™, Macy's™) want to know the people who come near their store locations on a regular basis. The system enables a retailer to incent this user behavior by providing users rewards in their games or other benefits.

Retailers want to drive store foot traffic. In another example embodiment, a system can enable appointment-based rewards by sending notifications in the form of flash alerts to mobile devices of users within a certain distance of a retailer's store at a specific time (e.g. Saturday at 2:00 pm, or Black Friday at 11:00 am) as part of a retailer's campaign. The numbers of users targeted in this campaign who actually come to the particular store are detected through a user's mobile device via a suitable system or application. Preferably using an application and recording equipment on the mobile device (e.g. camera-enabled phone handset), users directed to the retailer's store record machine readable coding (e.g. barcode scans/photos) of certain products at the retail store to quantify a return on the campaign investment for the retailer. Users who complete this task within a set interval of the alert (e.g. 1-3 hours) can be put into a lottery to randomly earn a discount on a store purchase of their choice for a certain monetary amount. Users can further receive a reward (e.g. $1) for completing a proof of presence via recording the machine readable coding during and completing assigned tasks provided by the retailer. Additional lottery-type rewards can be provided to lucky participating users. The retailer can observe return on investment from the campaign and ultimately boosting sales in a timely manner at specific times by driving increased foot traffic.

In another example embodiment, users achieve virtual rewards which due to their variable nature have unknown value until the rewards are conveyed. Using randomization and random number generation algorithms or location patterns unknown to users, the system rewards users with variable amounts of virtual rewards based on their everyday coordinate movements and positions recorded through a mobile locationing service. An entity such as a business, association, social organization, consumer brand owner, or retailer can direct variable reward patterns or reward quantities to incent a particular user behavior, experience, loyalty, or recognition to the entity. A user is incented to use the mobile locationing service for the potential for receiving rewards.

In another example embodiment, a user of a computer-based game achieves heightened status, achievement, and fanfare in the gaming environment through the successful recording of proof of presence at individual physical location areas or sets of physical location areas, wherein proof of presence is established by detecting entrance to or within a predetermined distance of physical venues, coordinates, or neighborhoods, which detection can occur by coordinate triangulation or other suitable locating process.

In another example embodiment, a set of mobile application users collaborate to complete a set of tasks, including but not limited to establishing physical proof of presences at particular locations defining a criteria set. The group as an aggregate is rewarded for establishing the proofs of presence of the individual group members whose combined actions achieve the criteria set.

In another example embodiment, users must appear in a methodical ordered progression of coordinates or location areas in order to achieve virtual rewards in a computing or mobile device application. The proof and ordering of these physical appearances are verified through coordinate triangulation or other suitable location process and recorded in a data table or database residing on a mobile device client or server. The user must achieve a set of physical proofs of presence in a unique ordered progression in time to achieve the virtual rewards in an application executed on the mobile device or remote system. For example, a user must firstly enter a specified shoe store, secondly enter a specified coffee shop, and thirdly enter a specified restaurant within a predetermined time period (e.g. one day) to achieve particular virtual rewards.

According to an embodiment of the invention, a system is provided configured to convert recorded physical movements into virtual rewards; and to render the virtual rewards accessible and visible to a user in a user interface of a mobile application. The physical movements can be detected using GPS signals, cell tower triangulation, Bluetooth signals, or Wi-Fi signals. The recorded physical movements can be converted into virtual rewards in the form of metadata, numerical points, status achievements, status levels, widgets, access to social networking services, access to information content or media, access to telecommunication services, and access to coupon rewards redeemable for purchase or discounts on real-world products or services. The virtual rewards can be rendered accessible and visible to a user in a user interface of an application such as a game, a widget, a personal fitness application, a healthcare application, a consumer safety or family locator service, an application aiding parents in parental duties of raising children, a social networking application, a virtual reality or avatar experience, a deal-based service, a mobile search or local information application, a geographic or mapping based service, or a service accessible or executed through a mobile device or other computing device.

While embodiments of the invention have been described in detail above, the invention is not limited to the specific embodiments described above, which should be considered as merely exemplary. Further modifications and extensions of the invention may be developed, and all such modifications are deemed to be within the scope of the invention as defined by the appended claims.

What is claimed is:

1. A computer-implemented value dissemination method comprising:
defining a physical location;
detecting entrance of a mobile device associated with a user to the physical location;
generating a value indication in response to detecting the entrance to the physical location; and
rendering the value indication accessible to the user.

2. The method of claim 1, further comprising generating the value indication in the form of a reward.

3. The method of claim 1, further comprising generating the value indication in the form of a negotiable virtual currency.

4. The method of claim 1, further comprising:
defining a plurality of physical locations;
detecting entrance of the mobile device associated with the user to the plurality of physical locations; and
generating the value indication in response to detecting the entrances to the plurality of physical locations.

5. The method of claim 4, further comprising increasing the value indication for each entrance to one of the plurality of physical locations.

6. The method of claim 4, further comprising generating the value indication in response to detecting the entrances to the plurality of physical locations in a predetermined ordered progression.

7. The method of claim 4, further comprising:
detecting entrances of a plurality of mobile devices associated with a plurality of users to the plurality of physical locations; and
generating the value indication in response to detecting the entrances to the plurality of physical locations by the plurality of mobile devices.

8. The method of claim 1, further comprising:
detecting entrances of a plurality of mobile devices associated with a plurality of users to the physical location; and
generating the value indication in response to detecting the entrances to the physical location by the plurality of mobile devices.

9. The method of claim 1, further comprising:
receiving a request for redemption of the value indication;
performing a value exchange including the value indication in response to the request for redemption; and
rendering an indication of the value exchange accessible to the user.

10. The method of claim 9, wherein performing the value exchange comprises exchanging the value indication for a store credit.

11. The method of claim 9, wherein performing the value exchange comprises exchanging the value indication for points in an application executed on at least one of the mobile device and a remote system in communication with the mobile device.

12. The method of claim 1, further comprising:
defining at least one of a prescribed day and a prescribed time of day;
detecting entrance of the mobile device to the physical location at the at least one of the prescribed day and the prescribed time of day; and
generating the value indication in response to detecting the entrance to the physical location at the at least one of the prescribed day and the prescribed time of day.

13. The method of claim 12, further comprising:
defining a prescribed duration of time;
detecting the presence of the mobile device at the physical location for at least the prescribed duration of time; and
generating the value indication in response to detecting the presence of the mobile device at the physical location for at least the prescribed duration of time.

14. The method of claim 1, further comprising:
detecting a purchase by the user at the physical location; and
generating a value indication in response to detecting the entrance to the physical location and detecting the purchase at the physical location.

15. The method of claim 14, further comprising detecting the purchase by the user by receiving machine readable coding via the mobile device.

16. The method of claim 14, further comprising performing a value exchange including the value indication, wherein performing the value exchange comprises at least one of exchanging the value indication for a store credit and exchanging the value indication for points in an application executed on at least one of the mobile device and a remote system in communication with the mobile device.

17. The method of claim 1, further comprising:
transmitting to at least one of the mobile device and the user an indication of a benefit obtainable at the physical location; and
generating a value indication in response to detecting the entrance to the physical location after the transmission of the indication of the benefit.

18. The method of claim 1, further comprising:
detecting entrance of a mobile device associated with a user to the physical location a plurality of times; and
increasing the value indication in response to detecting the entrance to the physical location the plurality of times.

19. The method of claim 1, further comprising rendering the value indication accessible to an application executed on the mobile device.

20. The method of claim 19, further comprising defining the physical location based on an indication of the physical location provided by the application executed on the mobile device.

21. The method of claim 1, further comprising:
defining a region related to the physical location;
detecting entrance of the mobile device to the region;
transmitting a notification to the mobile device related to the physical location; and
generating the value indication in response to detecting the entrance to the physical location after the transmission of the notification.

22. The method of claim 21, further comprising:
detecting machine readable coding associated with the notification via the mobile device; and
generating the value indication further in response to detecting the machine readable coding after the transmission of the notification.

23. The method of claim 21, further comprising:
transmitting at least one notification to the mobile device respectively related to a plurality of physical locations;
increasing the value indication in response to detecting the entrance to each of the plurality of physical locations after the transmission of the respective at least one notification.

24. The method of claim 21, further comprising defining the region related to the physical location as an area within a predetermined distance of the physical location.

25. The method of claim 1, further comprising:
receiving an indication of the physical location including at least one of an address and a geographic coordinate; and
defining the physical location as an area based on the at least one of the address and the geographic coordinate.

26. The method of claim 1, further comprising
transmitting a notification to the user related to the physical location; and
generating the value indication in response to detecting the entrance to the physical location within a predetermined time of transmitting the notification.

27. The method of claim 1, further comprising:
defining a plurality of physical locations;
transmitting a notification to the user related to the plurality of physical locations; and
generating the value indication in response to detecting the entrance to each of the plurality of physical locations within a predetermined time of transmitting the notification.

28. The method of claim 1, further comprising:
transmitting a notification to the user related to at least one product at the physical location;
detecting machine readable coding associated with the at least one product via the mobile device; and
generating the value indication further in response to detecting the machine readable coding after the transmission of the notification.

29. The method of claim 1, further comprising:
receiving indication of a particular user-interactive application executed via the mobile device; and
generating the value indication in response to detecting the entrance to the physical location and in response to receiving the indication of the particular user-interactive application executed via the mobile device.

30. The method of claim 29, wherein the particular user-interactive application is a gaming application, and wherein the value indication is generated in response to detecting a presence of the mobile device at the physical location for a predetermined period of time during user-interaction with the gaming application.

31. A system for disseminating value comprising at least one computing device including at least one memory comprising instructions operable to enable the at least one computing device to perform a procedure comprising:
defining a physical location;
detecting entrance of a mobile device associated with a user to the physical location;
generating a value indication in response to detecting the entrance to the physical location; and
rendering the value indication accessible to the user.

32. A mobile device comprising at least one computing device including at least one memory comprising instructions operable to enable the at least one computing device to perform a procedure comprising:
defining a physical location;
detecting entrance of the mobile device to the physical location;
generating a value indication associated with a user of the mobile device in response to detecting the entrance to the physical location; and
rendering the value indication accessible to an application executed on the mobile device.

33. A computer-implemented method comprising:
converting recorded physical movements into virtual rewards; and
rendering the virtual rewards accessible and visible to a user in a user interface of a mobile application.

34. The computer-implemented method of claim 33, further comprising detecting the physical movements using at least one of GPS signals, cell tower triangulation, Bluetooth signals, Wi-Fi signals.

35. The computer-implemented method of claim 33, further comprising converting the recorded physical movements into virtual rewards in the form of at least one of metadata, numerical points, status achievements, status levels, widgets, access to social networking services, access to information content or media, access to telecommunication services, and access to coupon rewards redeemable for purchase or discounts on real-world products or services.

36. The computer-implemented method of claim 33, further comprising rendering the virtual rewards accessible and visible to a user in a user interface of a mobile application including at least one of a game, a widget, a personal fitness application, a healthcare application, a consumer safety or family locator service, an application aiding parents in parental duties of raising children, a social networking application, a virtual reality or avatar experience, a deal-based service, mobile search or local information application, a geographic or mapping based service, and a service accessible or executed through a mobile device or other computing device.
